(19) United States
(12) Patent Application Publication
(10) Pub. No.: US 2004/0160332 A1
(43) Pub. Date: Aug. 19, 2004

(54) Improved Method for Stock Retrieval

(75) Inventor: Daniel C. Perry, Henderson, NV (US)

Correspondence Address: ADS SPECIALISTS, INC, 2657 WINDMILL PKWY #168, HENDERSON, NV, 89074, US

(73) Assignee: ADS SPECIALISTS, INC., Henderson, NV (US)

(21) Appl. No.: 10/708,160

(22) Filed: Feb. 12, 2004

Related U.S. Application Data
(60) Provisional application No. 60/481,122, filed on Jul. 22, 2003.
(60) Provisional application No. 60/319,950, filed on Feb. 15, 2003.

(51) Int. Cl. G08B 5/00

(52) U.S. Cl. 340/815.4

(57) ABSTRACT

This invention describes a method to efficiently identify to a worker needed boxes, totes or product for action. The invention does not require any special mechanical material handling equipment. The invention uses a battery powered addressable radio receiver (a “container pager”) that is individually attached to containers, storage locations or product. A “host” system generates a signal which is transmitted to an individually addressed receiver. When this signal is received by the addressed receiver, the “container pager” will either activate a light or other signaling means to alert a worker. The worker identifies the container that is being addressed and takes appropriate action. A variation of the invention includes a means for the container pager itself to active a transmitter in the container pager (two way paging). This pager generated transmission is used to either acknowledgement of an action by the worker or to identify the location of the container through the receipt of the container pager signal by other receivers.

### CROSS REFERENCE To RELATED APPLICATIONS

This Non-Provisional patent application is an extension of two previously submitted Provisional applications: 60/319,950, Filing Date Feb. 15, 2003, Application Dispatched from Preexam. Not Yet Docketed. and 60/481,122, Filing Date Jul. 22, 2003, Application Dispatched from Preexam. Not Yet Docketed

### BACKGROUND OF INVENTION

1. Field of the Invention

This device relates to a material handling equipment used to retrieve needed product or containers in a distribution center or a warehouse.

2. Prior Art and Objects of the Invention

RF identification equipment has been used to identify product as it is moved by readers that can detect the presence of a particular RF tag. If however, the product is stationary, this equipment is not suitable for use. Automated storage and retrieval equipment is commonly used to retrieve needed material. However, to create a manually operated storage and retrieval area, workers have been directed to the location containing the desired material. This invention allows goods to be placed manually in any available location without the need to record the location. When retrieval is desired, the material may be “paged” to activate a container retrieval light or sound an audible retrieval signal to direct a worker to retrieve the product. The object of this invention is an addressable device that may be automatically activated to indicate to the user an action to take. Other objects and advantages of the present invention will become apparent to those of ordinary skill in the art as the description thereof proceeds.

### SUMMARY OF INVENTION

This invention describes a method to efficiently identify to a worker needed boxes, totes or product for action. The invention does not require any special mechanical material handling equipment. The invention uses a battery powered addressable radio receiver (a “container pager”) that is individually attached to containers, storage locations or product. A “host” system generates a signal which is transmitted to an individually addressed receiver. When this signal is received by the addressed receiver, the “container pager” will either activate a light or other signaling means to alert a worker. The worker identifies the container that is being addressed and takes appropriate action. A variation of the invention includes a means for the container pager itself to activate a transmitter in the container pager (two way paging). This pager generated transmission is used for either acknowledgement of an action by the worker or to identify the location of the container through the receipt of the container pager signal by other receivers.

### BRIEF DESCRIPTION OF DRAWINGS

FIG. 1 is front view depiction of portion of a storage rack for holding of product utilizing “container pagers”.

### DETAILED DESCRIPTION

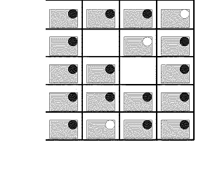

Referring now to FIG. 1, a rack is depicted that may hold up to 20 containers. The rack shown is occupied by 18 containers. The containers have attached “container pagers” which may be independently activated. Containers may be put away in any rack location randomly by a worker. The control system has no necessity of knowing precisely where any particular container has been placed. The controls system wishes to have action taken on one or more of the said containers. The control system causes a signal to be transmitted that will activate the desired receivers, which will cause the addressed container to provide a signal to a nearby worker to take some action. Although only this embodiment of the present invention has been described in detail, it should be understood that the present invention might be embodied in many other specific forms without departing from the spirit or scope of the invention. It will be apparent that each of the described components could be varied to a large degree. Therefore, the present examples and embodiments are to be considered as illustrative and not restrictive, and the invention is not to be limited to the details given herein, but may be modified within the scope of the appended claims.

A method to identify storage containers that require some action to be executed wherein the containers may have been stored or held in some location that is not required to be known to any information system, the said storage containers having a receiver capable of detecting a communication signal that is delivered to an associated decoder that uniquely identifies each individual container, the decoder capable of activating a action signaling means on the individual container, and a transmitting system generating said communication signal to direct an action.

1). A method as recited in claim 1 wherein the transmitter and receiver communication signal uses a radio frequency for receiver activation.

2). A method as recited in claim 1 wherein the transmitter and receiver communication signal uses a light for receiver activation.

3). A method as recited in claim 1 wherein the receiver decoder id is additionally connected to a transmitter and the purpose of the transmitter is to provide a signal which will allow the location of the container.

4). A method as recited in claim 1 wherein the receiver decoder id is additionally connected to a transmitter and the purpose of the transmitter is to provide an action acknowledgement signal.
